(19) United States
(12) Patent Application Publication
(10) Pub. No.: US 2021/0329511 A1
(43) Pub. Date: Oct. 21, 2021

(54) Resume Failure Handling After Cell Reselection

(71) Applicant: Google LLC, Mountain View, CA (US)

(72) Inventor: Teming Chen, Taipei City (TW)

(73) Assignee: Google LLC, Mountain View, CA (US)

(21) Appl. No.: 17/265,149

(22) PCT Filed: Aug. 9, 2019
(86) PCT No.: PCT/US2019/045874

§ 371 Date: Feb. 1, 2021

Related U.S. Application Data
(60) Provisional application No. 62/716,567, filed on Aug. 9, 2018.

(51) Int. Cl. H04W 36/00; H04W 36/08; H04W 76/19; H04W 48/20; H04W 48/16; H04W 76/30; H04W 68/00

(52) U.S. Cl. CPC H04W 36/0079; H04W 36/00837; H04W 36/08; H04W 68/005; H04W 48/20; H04W 48/16; H04W 76/30; H04W 76/19

(57) ABSTRACT

This document describes techniques and apparatuses for the handling of an RRC connection resume procedure failure after cell reselection in a UE. In aspects, the UE selects a first cell and enters a radio resource inactive state with the first cell. The UE detects a trigger from a lower layer or an upper layer of the UE. Responsive to detecting the trigger, the UE starts a first timer. The trigger initiates an RRC connection resume procedure. Responsive to the trigger, the UE transmits an RRC connection resume request message to the first cell. Before the first timer expires, the UE initiates a cell reselection procedure to select a second cell. The UE stops the RRC connection resume procedure and then enters a radio resource idle state.

### BACKGROUND

The evolution of wireless communication to Fifth Generation (5G) standards and technologies provides higher data rates and greater capacity, with improved reliability and lower latency, which enhances mobile broadband services. 5G technologies also provide new classes of services for vehicular networking, fixed wireless broadband, and the Internet of Things (IoT).

In response to a request from an upper layer or a trigger received by a lower layer, a user equipment in a radio resource control (RRC) inactive mode may perform an RRC connection resume procedure in order to transition to an RRC connected mode. To initiate the RRC connection resume procedure, the user equipment sends an RRC connection resume request message to the network to which the user equipment is connected. After sending the request message to the network, the user equipment may receive a message from the network rejecting the resumption of the RRC connection.

One reason that the network may reject the resumption of the RRC connection is due to cell reselection during the RRC connection resume procedure. A user equipment selects a serving cell, through a process referred to as cell reselection, can select to a suitable neighbor cell in the same radio access technology (RAT) or a different RAT. Cell reselection is the mechanism by which a user equipment, selected to a serving cell, selects a suitable neighbor cell in the same radio access technology (RAT) or a different RAT. According to current specification, when the network rejects the resumption of the RRC connection is due to cell reselection during the RRC connection resume procedure, the user equipment informs the upper layers of the user equipment's wireless networking stack of the resume failure for the purposes of having the upper layers handle the error. This can be an issue, in that the RRC connection resume procedure was not triggered by the upper layers.

### SUMMARY

Techniques and apparatuses are described for handling radio resource control (RRC) connection resume procedure failures after cell reselection. These techniques and apparatuses improve the handling of RRC connection resume procedure failures, thereby increasing the battery life of the user equipment, increasing the battery life of the user equipment, decreasing power usage by the network, and freeing up network resources.

Aspects described below include methods of handling an RRC connection resume procedure failure after cell reselection.

Aspects described below also include one or more computer-readable storage media storing executable instructions, that, responsive to execution by a processor, implement procedures for handling RRC connection resume procedure failures after cell reselection in a user equipment.

Aspects described below also include one or more computer-readable storage media storing executable instructions, that, responsive to execution by a processor, implement procedures for handling RRC connection resume procedure failures after cell re selection.

Aspects described below also include a system comprising means for performing procedures for handling RRC connection resume procedure failures after cell reselection.

### BRIEF DESCRIPTION OF THE DRAWINGS

Apparatuses for and techniques of handling of a radio resource control (RRC) connection resume procedure failure after cell reselection are described with reference to the following drawings. The same numbers are used throughout the drawings to reference like features and components:

FIG. 1 illustrates an example wireless network environment in which various aspects of the handling of an RRC connection resume procedure failure after cell reselection can be implemented.

FIG. 2 illustrates an example device diagram for devices that can implement various aspects of the handling of an RRC connection resume procedure failure after cell reselection can be implemented.

FIG. 3 illustrates example resource control states that may implement various aspects of an RRC connection resume procedure failure after cell reselection can be implemented.

FIG. 4 illustrates an example environment in which the handling of an RRC connection resume procedure failure after cell reselection can be implemented.

FIG. 5 illustrates an example of wireless networking stack with which aspects of the handling of an RRC connection resume procedure failure after cell reselection can be implemented.

FIG. 6 illustrates an example method of a user equipment for the handling of an RRC connection resume procedure failure after cell reselection.

FIG. 7 illustrates another example method of a user equipment for the handling of an RRC connection resume procedure failure after cell reselection.

### DETAILED DESCRIPTION

### Overview

This document describes techniques and apparatuses for handling radio resource control (RRC) connection resume procedure failures after cell reselection (e.g., in a user equipment). These techniques and apparatuses improve the handling of RRC connection resume procedure failures, decreasing the number of failures that are needlessly received, thereby increasing the battery life of the user equipment, increasing the battery life of the user equipment, decreasing power usage by the wireless network, and freeing up network resources.

While features and concepts of the described systems and methods for the handling of an RRC connection resume procedure failure after cell reselection can be implemented in any number of different environments, systems, devices, and/or various configurations, aspects of the handling of an RRC connection resume procedure failure after cell reselection are described in the context of the following example devices, systems, and configurations.

As used herein, a phrase referring to “at least one of a list of” items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Example Environment

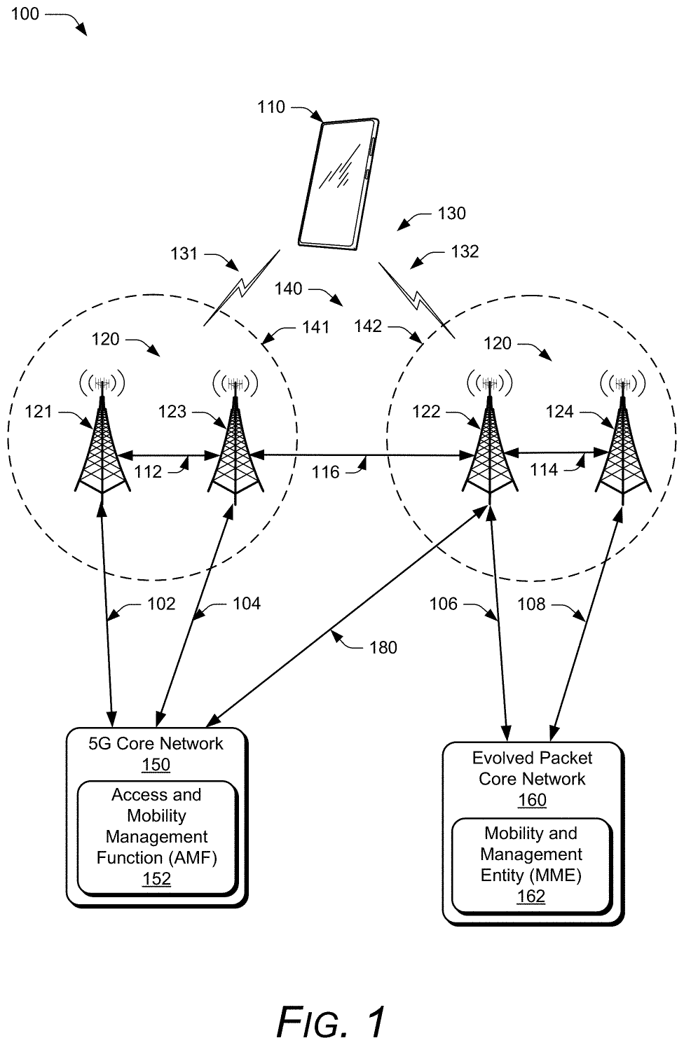

FIG. 1 is an illustration of an example wireless network environment in which various aspects of the handling of RRC connection resume procedure failures after cell reselection (e.g., in a user equipment) may be embodied. In the example environment 100, a user equipment 110 (UE 110) communicates with one or more base stations 120 (illustrated as base stations 121, 122, 123, and 124) through one or more wireless communication links 130 (wireless link 130), illustrated as wireless links 131 and 132. Although illustrated as a smartphone, the UE 110 may be implemented as any suitable computing or electronic device, such as a mobile communication device, a modem, cellular phone, gaming device, navigation device, media device, laptop computer, desktop computer, tablet computer, smart appliance, vehicle-based communication system, and the like. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

The base stations 120 communicate with the UE 110 through the wireless links 131 and 132, which may be implemented as any suitable type of wireless link. The wireless link 131 and 132 can include a downlink of data and control information communicated from the base stations 120 to the UE 110, an uplink of other data and control information communicated from the UE 110 to the base stations 120, or both. The wireless links 130 may include one or more wireless links or bearers implemented using any suitable communication protocol or standard, or combination of communication protocols or standards such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (RAN 140, Evolved Universal Terrestrial Radio Access Network, E-UTRAN, 5G NR RAN, NR RAN). The RANs 140 are illustrated as an NR RAN 141 and an E-UTRAN 142. The base stations 121 and 123 in the NR RAN 141 are connected to a Fifth Generation Core 150 (5GC 150) network. The base stations 122 and 124 in the E-UTRAN 142 are connected to an Evolved Packet Core 160 (EPC 160). Optionally or additionally, a base station 122 in the E-UTRAN 142 may connect to the 5GC 150 and EPC 160 networks.

The base stations 121 and 123 connect, at 102 and 104 respectively, to the 5GC 150 through an NG2 interface for control-plane signaling and through an NG3 interface for user-plane data communications. The base stations 122 and 124 connect, at 106 and 108 respectively, to the EPC 160 through an S1 interface for control-plane signaling and user-plane data communications. Optionally or additionally, if the base station 122 connects to the 5GC 150 and EPC 160 networks, the base station 122 connects to the 5GC 150 through an NG2 interface for control-plane signaling and through an NG3 interface for user-plane data communications, at 180.

In addition to connections to core networks, base stations 120 may communicate with each other. The base stations 121 and 123 communicate through an Xn interface at 112. The base stations 122 and 124 communicate through an X2 interface at 114. The base station 122, which is connected to both the 5GC 150 and the EPC 160, may communicate with the base stations 121 and/or 123 using the Xn interface, as illustrated at 116.

The 5GC 150 includes an Access and Mobility Management Function 152 (AMF 152) that provides control-plane functions such as registration and authentication of multiple UE 110, authorization, mobility management, or the like in the 5G NR network. The EPC 160 includes a Mobility and Management Entity 162 (MME 162) that provides control-plane functions such as registration and authentication of multiple UE 110, authorization, mobility management, or the like in the E-UTRA network. The AMF 152 and the MME 162 communicate with the base stations 120 in the RANs 140 and communicate with multiple UE 110, through the base stations 120.

Example Devices

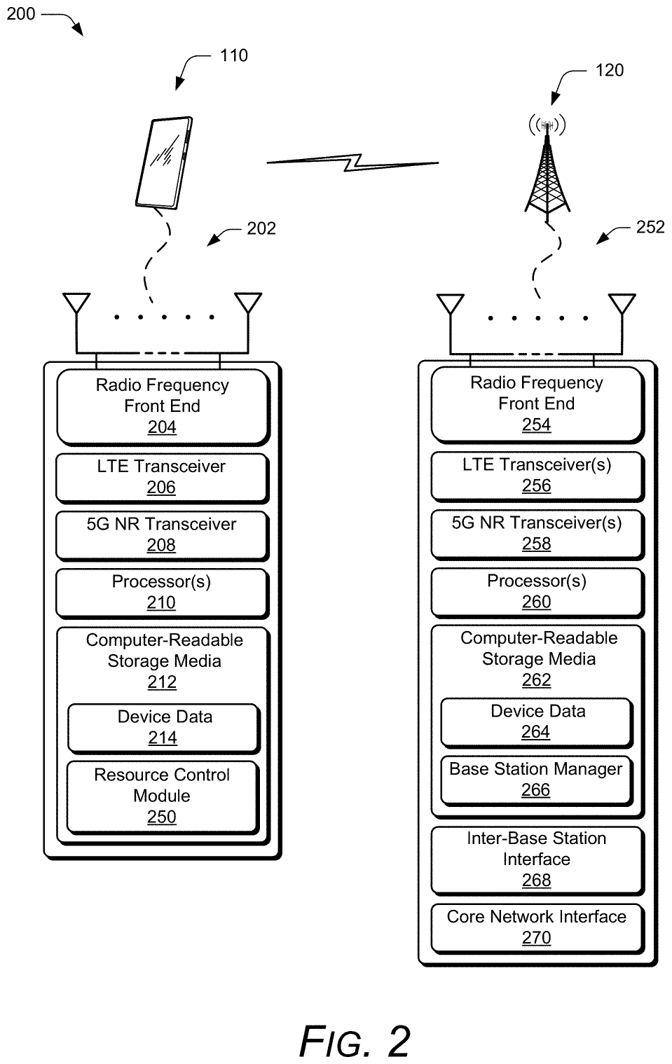

FIG. 2 illustrates example device diagrams 200 of the UE 110 and the base station 120. The UE 110 and the base station 120 may include additional functions and interfaces that are omitted from FIG. 2 for the sake of clarity.

The UE 110 includes antennas 202, a radio frequency front end 204 (RF front end 204), one or more an LTE transceiver(s) 206, and one or more 5G NR transceiver(s) 208 for communicating with the base station 120 in the 5G RAN 141 and/or the E-UTRAN 142. The RF front end 204 of the UE 110 can couple or connect the LTE transceiver 206 and/or the 5G NR transceiver 208 to the antennas 202 to facilitate various types of wireless communication. The antennas 202 of the UE 110 may include an array of multiple antennas that are configured similarly to or different from each other. The antennas 202 and the RF front end 204 can be tuned to, and/or be tunable to, one or more frequency bands defined by the 3GPP LTE and 5G NR communication standards and implemented by the LTE transceiver 206 and/or the 5G NR transceiver 208. Additionally, the antennas 202, the RF front end 204, the LTE transceiver 206, and/or the 5G NR transceiver 208 may be configured to support beamforming for the transmission and reception of communications with the base station 120. By way of example and not limitation, the antennas 202 and the RF front end 204 can be implemented for operation in sub-gigahertz bands, sub-6 GHz bands, and/or above 6 GHz bands that are defined by the 3GPP LTE and 5G NR communication standards.

The UE 110 also includes processor(s) 210 and computer-readable storage media 212 (CRM 212). The processor 210 may be a single-core processor or a multiple-core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the UE 110. The device data 214 includes user data, multimedia data, beamforming codebooks, applications, and/or an operating system of the UE 110, which are executable by the processor(s) 210 to enable user-plane communication, control-plane signaling, and user interaction with the UE 110.

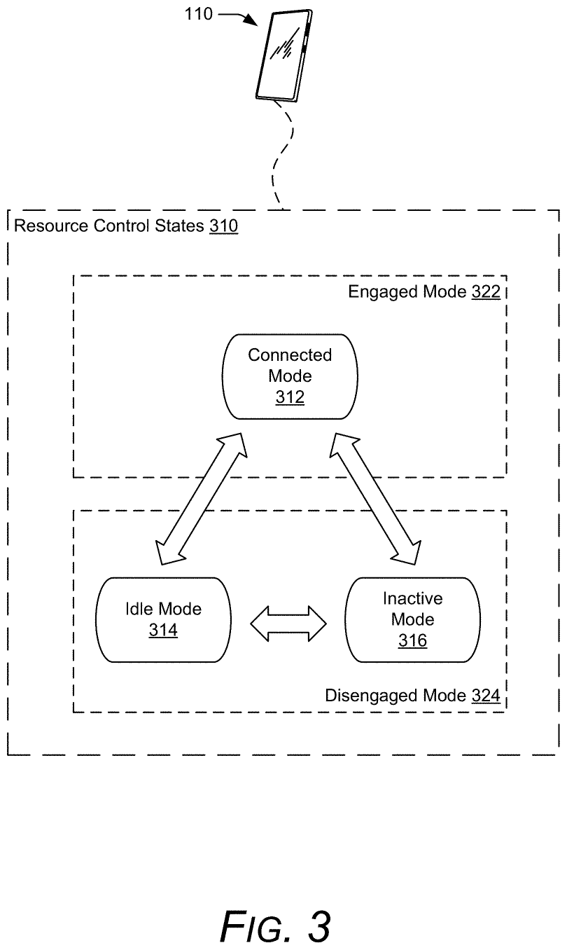

CRM 212 also includes a resource control module 250. Alternatively or additionally, the resource control module 250 may be implemented in whole or part as hardware logic or circuitry integrated with or separate from other components of the UE 110. In at least some aspects, the resource control module 250 handles RRC connection resume procedure failures after cell reselection to implement the techniques described herein. The resource control module 250 can implement an RRC layer/entity. The resource control module 250 determines the resource control state 310 (e.g., the connected mode 312, the inactive mode 316, the idle mode 314) and causes the wireless transceiver (e.g., LTE transceiver 206, 5G NR transceiver 208) to perform operations according to the resource control state 310. To avoid wasting network resources or delaying communications, the resource control module 250 can perform other actions prior to or instead of performing the connection resume procedure, as described in FIG. 3. The resource control module 250 can at least partially implement the handling of an RRC connection resume procedure failure after cell reselection in a UE 110, as further described in FIGS. 3-7.

The device diagram for the base station 120, illustrated in FIG. 2, includes a single network node (e.g., a gNode B). The functionality of the base station 120 may be distributed across multiple network nodes or devices and may be distributed in any fashion suitable to perform the functions described herein. The base station 120 includes antennas 252, a radio frequency front end 254 (RF front end 254), one or more LTE transceivers 256, and/or one or more 5G NR transceivers 258 for communicating with the UE 110. The RF front end 254 of the base station 120 can couple or connect the LTE transceivers 256 and the 5G NR transceivers 258 to the antennas 252 to facilitate various types of wireless communication. The antennas 252 of the base station 120 may include an array of multiple antennas that are configured similarly to or different from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the UE 110.

The base station 120 also includes processor(s) 260 and computer-readable storage media 262 (CRM 262). The processor 260 may be a single-core processor or a multiple-core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base station 120. The device data 264 includes network scheduling data, radio resource management data, beamforming codebooks, applications, and/or an operating system of the base station 120, which are executable by the processor(s) 260 to enable communication with the UE 110.

CRM 262 also includes a base station manager 266. Alternatively or additionally, the base station manager 266 may be implemented in whole or part as hardware logic or circuitry integrated with or separate from other components of the base station 120. In at least some aspects, the base station manager 266 configures the LTE transceivers 256 and the 5G NR transceivers 258 for communication with the UE 110, as well as communication with a core network. The base station 120 includes an inter-base station interface 268, such as an Xn and/or X2 interface, which the base station manager 266 configures to exchange user-plane and control-plane data with another base station 120, to manage the communication of the base station 120 with the UE 110. The base station 120 includes a core network interface 270 that the base station manager 266 configures to exchange user-plane and control-plane data with core network functions and entities.

User Equipment States

FIG. 3 illustrates example resource control states 310 that may benefit from aspects of the handling of an RRC connection resume procedure failure after cell reselection (e.g., in a user equipment) can be implemented. A wireless network operator provides its telecommunication services to a user equipment 110 through a wireless network. To communicate wirelessly with the network, a UE 110 utilizes an RRC connection resume procedure to establish a connection to the network using a cell (e.g., a base station, a serving cell). Upon establishing the connection to the network using the base station 121, the UE 110 enters a connected mode 312 (e.g., RRC connected state, RRC_CONNECTED state, NR-RRC CONNECTED state, E-UTRA RRC CONNECTED state). In general, if the UE 110 is in the connected mode 312, the connection with the base station 121 is active.

The UE 110 operates according to different resource control states 310. Different situations may occur that cause the UE 110 to transition between different resource control states 310 as determined by the radio access technology. Examples of the resource control states 310 illustrated in FIG. 3 include a connected mode 312 (e.g., connected state), an inactive mode 316 (e.g., inactive state), and an idle mode 314 (e.g., idle state). A UE 110 is either in the connected mode 312 or in the inactive mode 316 when an RRC connection is active. If an RRC connection is not active, then the UE 110 is in the idle mode 314.

In establishing an RRC connection, the UE 110 may transition from the idle mode 314 to the connected mode 312. After establishing the connection, the UE 110 may transition (e.g., upon connection inactivation) from the connected mode 312 to an inactive mode 316 (e.g., RRC inactive mode, RRC_INACTIVE state, NR-RRC INACTIVE state) and the UE 110 may transition (e.g., through an RRC connection resume procedure) from the inactive mode 316 to the connected mode 312. After establishing the connection, the UE 110 may transition between the connected mode 312 to an idle mode 314 (e.g., RRC idle mode, RRC IDLE state, NR-RRC IDLE state, E-UTRA RRC IDLE state, 5GMM-IDLE), for instance upon the network releasing the RRC connection. The UE 110 may transition between the inactive mode 316 and the idle mode 314.

The UE 110 may be in an engaged mode 322 or may be in a disengaged mode 324. As used herein, an engaged mode 322 is a connected mode (e.g., the connected mode 312) and a disengaged mode 324 is an idle, disconnected, connected-but-inactive, or connected-but-dormant mode (e.g., idle mode 314, inactive mode 316). In some cases, in the disengaged mode 324, the UE 110 may still be Non-Access Stratum (NAS) registered with radio bearer active (e.g., inactive mode 316).

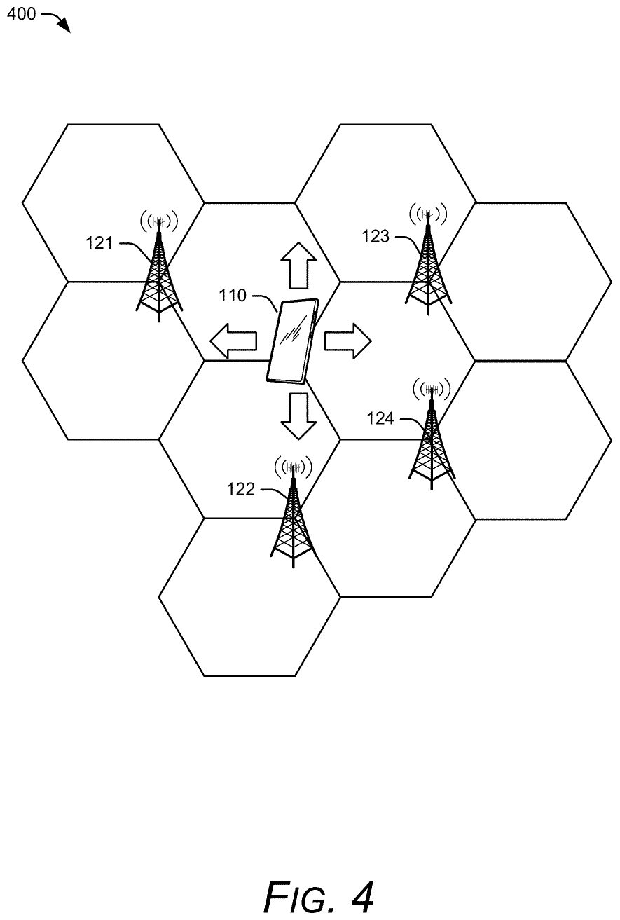

Each of the different resource control states 310 have different quantities or types of resources available, which may affect power consumption within the UE 110. In general, the connected mode 312 represents the UE 110 actively connected to (engaged with) the base station 121. In the inactive mode 316, the UE 110 suspends connectivity with the base station 121 and retains information that enables connectivity with the base station 121 to be quickly reestablished. In the idle mode 314, the UE 110 releases the connection with the base station 121. While in the inactive mode 316, the UE 110 may perform a cell-selection procedure. Some of the resource control states 310 may be limited to certain radio access technologies. For example, the inactive mode 316 may be supported in LTE Release 15 (eLTE), 5G NR, and 6G, but not in 3G or previous generations of 4G standards. Other resource control states may be common or compatible across multiple radio access technologies, such as the connected mode 312 and/or the idle mode 314. In the inactive mode 316 and/or the idle mode 314, the UE 110 may perform the cell-selection procedure, which is further described with respect to FIG. 4.

Resume Failure Handling

A cell may enable a connection to a network to be resumed from the inactive mode 316 through a connection resume procedure (e.g., an RRC connection resume procedure), which is further described with respect to FIG. 4. FIG. 4 illustrates an example environment 400 in which the UE 110 moves to different geographical locations. In FIG. 4, a map illustrates the UE 110 as being physically located between multiple base stations (e.g., base stations 120 of FIG. 1, cell sites), which are illustrated as base station 121, base station 123, base station 122, and base station 124.

Consider that the UE 110 is in an engaged mode 322 (e.g., connected mode 312). After the UE 110 establishes the connection with base station 121, base station 121 transmits a request message to the UE 110 that causes the UE 110 to transition from the engaged mode 322 to a disengaged mode 324 (e.g., inactive mode 316). The request message may comprise, for example, an RRC connection release message according to a suitable communication standard (e.g., eLTE, 5G NR).

While the UE 110 is in the disengaged mode 324 (e.g., inactive mode 316), the UE 110 may detect a trigger (e.g., trigger message) that initiates a connection resume procedure, such as an RRC connection resume procedure. The connection resume procedure enables the UE 110 to transition from the disengaged mode 324 (e.g., inactive mode 316) to the engaged mode 322 (e.g., connected mode 312) and to re-establish the connection to the network.

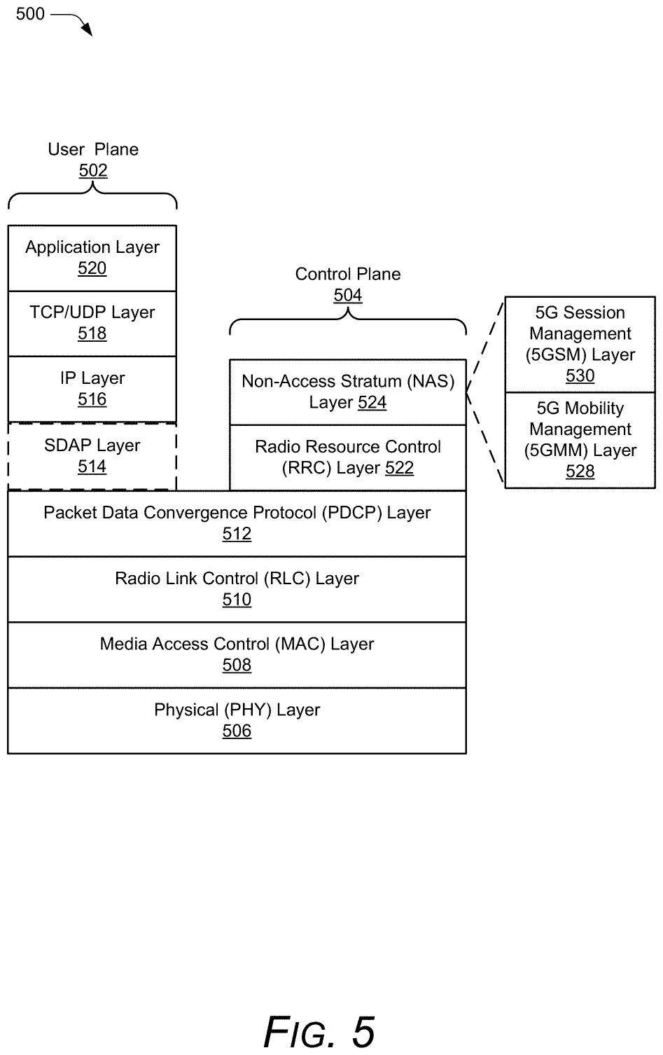

Different types of triggers may occur that initiate the connection resume procedure. For example, the connection resume procedure may be triggered by an upper layer request (e.g., non-access stratum (NAS) layer, a 5G mobility management (5GMM) layer), which is further described with respect to FIG. 5. As another example, the connection resume procedure may be triggered due to an RRC layer trigger (e.g., a periodic RAN notification area (RNA) update (RAN-based notification area update, RNA update), a periodic update, a RAN notification area change). The RNA update provides a single identity (e.g., a RAN area identity, a cell identity, a public land mobile network (PLMN) identity) or a list of identities (e.g., a list of cell identities) to the UE 110. In some situations, the RNA update may be triggered if a RAN notification area of the base station 123 is different than a RAN notification area of the base station 121. In other situations, an upper layer may send a request that triggers the RNA update and/or the connection resume procedure.

In response to the trigger, the UE 110 may transmit an RRC connection resume request message to the network (e.g., base station 121). After sending the RRC connection resume request message to the network, the UE 110 may receive a reject message (e.g., RRC connection resume failure) from the network. If the RRC connection resume procedure was triggered by an upper layer (e.g., NAS layer 524, 5GMM layer 528) request, upon receipt of the reject message, the UE 110 may inform the upper layers of the RRC connection resume failure and wait for the upper layer's error handling in disengaged mode 324. If an RRC layer 522 triggered the RRC connection resume procedure, the UE 110 may perform error handling by itself If the RRC connection resume failure was due to cell reselection during the RRC connection resume procedure, according to current specification, the UE 110 informs upper layers about the RRC connection resume failure. This is done even though the RRC connection resume was not triggered by the upper layers. Because the RRC connection resume procedure was not triggered by the upper layers, it is not suitable for the upper layers to perform the error handling.

As the UE 110 moves to a different geographical location while in the disengaged mode 324 (e.g., inactive mode 316), such as towards the base station 123, the UE 110 may perform another cell selection procedure to select or determine another cell (e.g., another base station 120). The cell selection procedure may also be referred to as a cell reselection procedure, which enables the UE 110 to change or switch to a suitable neighbor cell within the same radio access technology (RAT) or a different RAT.

Consider a case in which a UE 110, in a disengaged mode (e.g., inactive mode 316, RRC_INACTIVE state) with base station 121, initiates an RRC connection resume procedure with base station 121. The UE 110 starts a first timer (e.g., a T319 timer) and transmits an RRC connection resume request to the network (e.g., base station 121). Before the expiration of the first timer, the UE 110 performs a cell reselection procedure and selects to base station 123. After selecting to the base station 123, the UE 110 stops the first timer, if it is running, and the UE 110 stops the RRC connection resume procedure (the RRC connection resume procedure fails).

After stopping the RRC connection resume procedure, the UE 110 performs one or more of: (1) when the RRC connection resume procedure was triggered by the upper layers (e.g., through a request from the upper layers), the UE 110 informs the upper layer (e.g., NAS layer 524, 5GMM layer 528) of the RRC connection resume failure and the UE 110 enters another disengaged mode (e.g., idle mode 314, RRC_IDLE state); (2) when the RRC connection resume procedure was triggered by the UE 110 (e.g., triggered by a lower layer of the UE 110, triggered by the RRC layer 522 of the UE 110), the UE 110 postpones the RRC connection resume procedure; (3) when the RRC connection resume procedure was triggered by the UE 110 (e.g., triggered by a lower layer of the UE 110, triggered by the RRC layer 522 of the UE 110), the UE 110 restarts the RRC connection resume procedure; (4) when the RRC connection resume procedure was triggered by the UE 110 (e.g., triggered by a lower layer of the UE 110, triggered by the RRC layer 522 of the UE 110), the UE 110 stays in the inactive mode 316 (e.g., RRC_INACTIVE state) and sends an indication to inform upper layers about the RRC connection resume failure and to indicate that the UE 110 is still in a disengaged mode (e.g., inactive mode 316, RRC_INACTIVE state); and (5) when the RRC connection resume procedure was triggered by the UE 110 (e.g., triggered by a lower layer of the UE 110, triggered by the RRC layer 522 of the UE 110), the UE 110 stops the RRC connection resume procedure.

In some cases, prior to selecting to base station 123, the UE 110 is in a disengaged mode 324 (e.g., inactive mode 316, RRC_INACTIVE state) with base station 122 and the RRC connection resume procedure is triggered by the UE 110 (e.g., triggered by a lower layer of the UE 110, triggered by the RRC layer 522 of the UE 110) due to one or more of: a periodic RNA update, the RAN notification area of base station 123 is different than the RAN notification area of base station 122, or the RAN notification area of base station 123 does not belong to the RAN notification area of base station 122. In aspects, the RNA update can include one or more of: a list of cell identities, a list of RAN area identities, a list of PLMN identities, a cell identity, and a RAN area identity and a PLMN identity.

In aspects, prior to selecting to base station 123, the UE 110 is in a disengaged mode 324 (e.g., inactive mode 316, RRC_INACTIVE state) with base station 122 and the RRC connection resume procedure is triggered by the UE 110 (e.g., triggered by a lower layer of the UE 110, triggered by the RRC layer 522 of the UE 110) due to a periodic RNA update. Prior to selecting to base station 123, the UE 110 is in a disengaged mode 324 (e.g., inactive mode 316, RRC_INACTIVE state) with base station 122, the UE 110 starts a second timer (e.g., T380) when it enters the disengaged mode 324, and the UE 110 performs the periodic RNA update after the timer expires.

In some cases, prior to selecting base station 123, the UE 110 is in a disengaged mode 324 (e.g., inactive mode 316, RRC_INACTIVE state) with base station 122 and the UE 110 reinitiates the postponed RRC connection resume procedure in response to one or more of: a RAN notification area of base station 123 is different from a RAN notification area of base station 122, or the RAN notification area of base station 123 does not belong to the RAN notification area of the base station 122.

In one aspect, a UE 110, in a disengaged mode 324 (e.g., inactive mode 316, RRC_INACTIVE state) with base station 121, initiates an RRC connection resume procedure with base station 121. The UE 110 starts a first timer (e.g., T319) and transmits an RRC connection resume request to the network (e.g., base station 121). Before the expiration of the first timer, the UE 110 performs a cell reselection procedure and selects to base station 123 and considers base station 121 as a barred cell. After selecting the base station 123, the UE 110 stops the first timer, if it is running, and stops the RRC connection resume procedure. After stopping the RRC connection resume procedure, the UE 110 the performs one or more of: (1) when the RRC connection resume procedure was triggered by the upper layers (e.g., by an upper layer request), the UE 110 informs the upper layer (e.g., NAS layer 524, 5GMM layer 528) of the RRC connection resume failure and the UE 110 enters a disengaged mode 324 (e.g., idle mode 314, RRC_IDLE state); (2) when the RRC connection resume procedure was triggered by the UE 110 (e.g., triggered by a lower layer of the UE 110, triggered by the RRC layer 522 of the UE 110), the UE 110 postpones the RRC connection resume procedure; (3) when the RRC connection resume procedure was triggered by the UE 110 (e.g., triggered by a lower layer of the UE 110, triggered by the RRC layer 522 of the UE 110), the UE 110 restarts the RRC connection resume procedure; (4) when the RRC connection resume procedure was triggered by the UE 110 (e.g., triggered by a lower layer of the UE 110, triggered by the RRC layer 522 of the UE 110), the UE 110 stays in a disengaged mode 324 (e.g., inactive mode 316, RRC_INACTIVE state) and sends an indication to inform upper layers about the RRC connection resume failure and to indicate that the UE 110 is still in a disengaged mode 324 (e.g., inactive mode 316, RRC_INACTIVE state); and (5) when the RRC connection resume procedure was triggered by the UE 110 (e.g., triggered by a lower layer of the UE 110, triggered by the RRC layer 522 of the UE 110), the UE 110 stops the RRC connection resume procedure. In some cases, the UE 110 sends an indication informing upper layers that the base station 121 is a barred cell.

In one aspect, a UE 110, in a disengaged mode 324 (e.g., inactive mode 316, RRC_INACTIVE state) with base station 121, initiates an RRC connection resume procedure with base station 121. The UE 110 starts a first timer (e.g., T319) and transmits an RRC connection resume request to the network (e.g., base station 121). Before the expiration of the first timer, the UE 110 performs a cell reselection procedure and selects to base station 123 and considers base station 121 as a barred cell. After selecting to the base station 123, the UE 110 stops the first timer, if it is running, and stops the RRC connection resume procedure. After stopping the RRC connection resume procedure, the UE 110 the performs one or more of: (1) when the RRC connection resume procedure was triggered by the upper layers (e.g., by an upper layer request), the UE 110 informs the upper layer (e.g., NAS layer 524, 5GMM layer 528) of the RRC connection resume failure and the UE 110 enters a disengaged mode 324 (e.g., idle mode 314, RRC_IDLE state); (2) when the RRC connection resume procedure was triggered by the UE 110 (e.g., triggered by a lower layer of the UE 110, triggered by the RRC layer 522 of the UE 110), the UE 110 postpones the RRC connection resume procedure; (3) when the RRC connection resume procedure was triggered by the UE 110 (e.g., triggered by a lower layer of the UE 110, triggered by the RRC layer 522 of the UE 110), the UE 110 restarts the RRC connection resume procedure; (4) when the RRC connection resume procedure was triggered by the UE 110 (e.g., triggered by a lower layer of the UE 110, triggered by the RRC layer 522 of the UE 110), the UE 110 stays in a disengaged mode 324 (e.g., inactive mode 316, RRC_INACTIVE state) and sends an indication to inform upper layers about the RRC connection resume failure and to indicate that the UE 110 is still in a disengaged mode 324 (e.g., inactive mode 316, RRC_INACTIVE state); and (5) when the RRC connection resume procedure was triggered by the UE 110 (e.g., triggered by a lower layer of the UE 110, triggered by the RRC layer 522 of the UE 110), the UE 110 stops the RRC connection resume procedure. After barring base station 121, the UE 110 starts a third timer. After the third timer expires, at least one of the UE 110 sends an indication informing an upper layer that barring base station 121 alleviated the RRC connection resume procedure, or the UE 110 directs an upper layer to reinitiate the RRC connection resume procedure.

In one aspect, a UE 110, in a disengaged mode 324 (e.g., inactive mode 316, RRC_INACTIVE state) with base station 121, initiates an RRC connection resume procedure with base station 121. The UE 110 starts a first timer (e.g., T319) and transmits an RRC connection resume request to the network (e.g., base station 121). Before the expiration of the first timer, the UE 110 performs a cell reselection procedure and selects to base station 123 and considers base station 121 as a barred cell. After selecting to the base station 123, the UE 110 stops the first timer, if it is running, and stops the RRC connection resume procedure. After stopping the RRC connection resume procedure, the UE 110 postpones the RRC connection resume procedure and starts a fourth timer. The UE 110 reinitiates the RRC connection resume procedure after the fourth timer expires. In some cases, the UE 110 reselects base station 124 before the fourth timer expires. In some cases, the UE 110 stops the fourth timer, if it is running, and reinitiates the RRC connection resume procedure when (a) the RAN notification area of base station 123 and base station 124 are different or (b) the RAN notification area of base station 123 does not belong to the RAN notification area of base station 124.

In one aspect, a UE 110, in a disengaged mode 324 (e.g., inactive mode 316, RRC_INACTIVE state) with base station 121, initiates an RRC connection resume procedure with base station 121. Prior to the selection of base station 121, the UE 110 is in a disengaged mode 324 with base station 124. The UE 110 starts a first timer (e.g., T319) and transmits an RRC connection resume request to the network (e.g., base station 121). Before the expiration of the first timer, the UE 110 performs a cell reselection procedure and selects to base station 123. After selecting to the base station 123, the UE 110 stops the first timer, if it is running, and stops the RRC connection resume procedure. After stopping the RRC connection resume procedure, the UE 110 restarts the RRC connection resume procedure when (a) the RAN notification area of base station 123 and the RAN notification area of base station 124 are different or (b) the RAN notification area of base station 123 does not belong to the RAN notification area of base station 124. In some cases, the UE 110 enters a disengaged mode 324 (e.g., inactive mode 316, RRC_INACTIVE state) without performing the RRC connection resume procedure when (a) the RAN notification area of base station 123 and the RAN notification area of base station 124 are the same or (b) the RAN notification area of base station 123 belongs to the RAN notification area of base station 124.

In one aspect, a UE 110 in a disengaged mode 324 (e.g., inactive mode 316, RRC_INACTIVE state) with base station 121, initiates an RRC connection resume procedure with base station 121. The UE 110 starts a first timer (e.g., T319) and transmits an RRC connection resume request to the network (e.g., base station 121). Before the expiration of the first timer, the UE 110 performs a cell reselection procedure and selects base station 123. After selecting base station 123, the UE 110 stops the first timer, if it is running, and stops the RRC connection resume procedure. After stopping the RRC connection resume procedure, the UE 110 the performs one or more of: (1) when the RRC connection resume procedure was triggered by the upper layers (e.g., by an upper layer request), the UE 110 informs the upper layer (e.g., NAS layer 524, 5GMM layer 528) of the RRC connection resume failure and the UE 110 enters a disengaged mode 324 (e.g., idle mode 314, RRC_IDLE state); (2) when the RRC connection resume procedure was triggered by the UE 110 (e.g., triggered by a lower layer of the UE 110, triggered by the RRC layer 522 of the UE 110), the UE 110 postpones the RRC connection resume procedure; (3) when the RRC connection resume procedure was triggered by the UE 110 (e.g., triggered by a lower layer of the UE 110, triggered by the RRC layer 522 of the UE 110), the UE 110 restarts the RRC connection resume procedure; (4) when the RRC connection resume procedure was triggered by the UE 110 (e.g., triggered by a lower layer of the UE 110, triggered by the RRC layer 522 of the UE 110), the UE 110 stays in a disengaged mode 324 (e.g., inactive mode 316, RRC_INACTIVE state) and sends an indication to inform upper layers about the RRC connection resume failure and to indicate that the UE 110 is still in a disengaged mode 324 (e.g., inactive mode 316, RRC_INACTIVE state); and (5) when the RRC connection resume procedure was triggered by the UE 110 (e.g., triggered by a lower layer of the UE 110, triggered by the RRC layer 522 of the UE 110), the UE 110 stops the RRC connection resume procedure. The UE 110 discards any stored access stratum (AS) context, Radio Network Temporary Identifier I-RNTI, information elements ran-PagingCycle and ran-NotificationAreaInfo when entering a disengaged mode 324 (e.g., idle mode 314, RRC_IDLE state). In some cases, the UE 110 releases one or more of the radio link control (RLC) entity, the medium access control (MAC) configuration, or the associated Packet Data Convergence Protocol (PDCP) entity for all established radio bearers (RBs).

User Plane and Control Plane Signaling

FIG. 5 illustrates an example block diagram of a wireless network stack model 500 that characterizes a communication system for the example environment 100, in which various aspects of an inter-radio access technology handover can be implemented. In reference to the protocol stack, the terms “upper layer” and “lower layer” are relative to one another, with each layer in the protocol stack being an “upper layer” to a layer lower in the protocol stack (a “lower layer”). For example, an upper layer may correspond to the NAS layer 524, the upper layer may correspond to a 5GMM layer 528, and/or a lower layer may correspond to the Access Stratum layer (AS layer). The lower layer may also correspond to an RRC layer. A protocol stack may support various protocol layers, including NAS, RRC, Packet Data Convergence Protocol (PDCP), Radio Link Control (RLC), Medium Access Control (MAC), and Physical Layer (PHY).

The wireless network stack 500 includes a user plane 502 and a control plane 504. Upper layers of the user plane 502 and the control plane 504, share common lower layers in the wireless network stack 500. Wireless devices, such as the UE 110 or base stations 120, implement each layer as an entity for communication with another device using the protocols defined for the layer. For example, a UE 110 uses a Packet Data Convergence Protocol (PDCP) entity to communicate to a peer PDCP entity in a base station 120 using the PDCP.

The shared lower layers include a physical layer 506 (PHY layer 506), a Media Access Control layer 508 (MAC layer 508), a Radio Link Control layer 510 (RLC layer 510), and a Packet Data Convergence Protocol layer 512 (PDCP layer 512). The physical layer 506 provides hardware specifications for devices that communicate with each other. As such, the physical layer 506 establishes how devices connect to each other, assists in managing how communication resources are shared among devices, and the like.

The MAC layer 508 specifies how data is transferred between devices. Generally, the MAC layer 508 provides a way in which data packets being transmitted are encoded and decoded into bits as part of a transmission protocol.

The RLC layer 510 provides data transfer services to higher layers in the wireless network stack 500. Generally, the RLC layer 510 provides error correction, packet segmentation and reassembly, and management of data transfers in various modes, such as acknowledged, unacknowledged, or transparent modes.

The PDCP layer 512 provides data transfer services to higher layers in the wireless network stack 500. Generally, the PDCP layer 512 provides transfer of user plane 502 and control plane 504 data, header compression, ciphering, and integrity protection.

Above the PDCP layer 512, the wireless network stack splits into the user-plane stack 502 and the control-plane stack 504. The user plane 502 layers include an optional Service Data Adaptation Protocol layer 514 (SDAP layer 514), an Internet Protocol layer 516 (IP layer 516), a Transmission Control Protocol/User Datagram Protocol layer 518 (TCP/UDP layer 518), and an application layer 520 that transfer data through the wireless link 106. The optional SDAP layer 514 is present in 5G NR networks and maps a Quality of Service (QoS) flow for each data radio bearer and marks QoS flow identifiers in uplink and downlink data packets for each packet data session. The IP layer 516 specifies how the data from the application layer 520 is transferred to a destination node. The TCP/UDP layer 518 is used to verify that data packets intended to be transferred to the destination node reached the destination node, using either TCP or UDP for data transfers by the application layer 520.

The control plane 504 includes Radio Resource Control layer 522 (RRC layer 522) and a Non-Access Stratum layer 524 (NAS layer 524). The RRC layer 522 establishes and releases connections and radio bearers, broadcasts system information, performs power control, and so forth. The NAS layer 524 provides support for mobility management and packet data bearer contexts between the user equipment 110 and entities or functions in the core network, such as the Access and Mobility Management Function 152 (AMF 152), or the Mobility Management Entity 162 (MME 162), or the like.

In the UE 110, each layer in both the user plane 502 and the control plane 504 of the wireless network stack 500 interacts with a corresponding peer layer or entity in a base station 120, a core network entity or function, and/or a remote service, to support user applications and control operation of the UE 110 in the NR RAN 141 or the E-UTRAN 142.

Example Methods

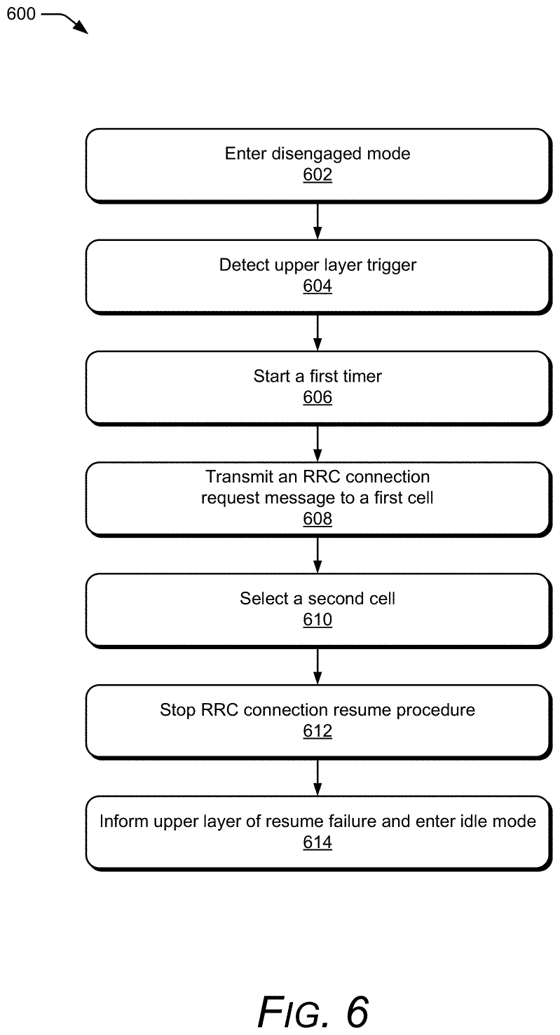

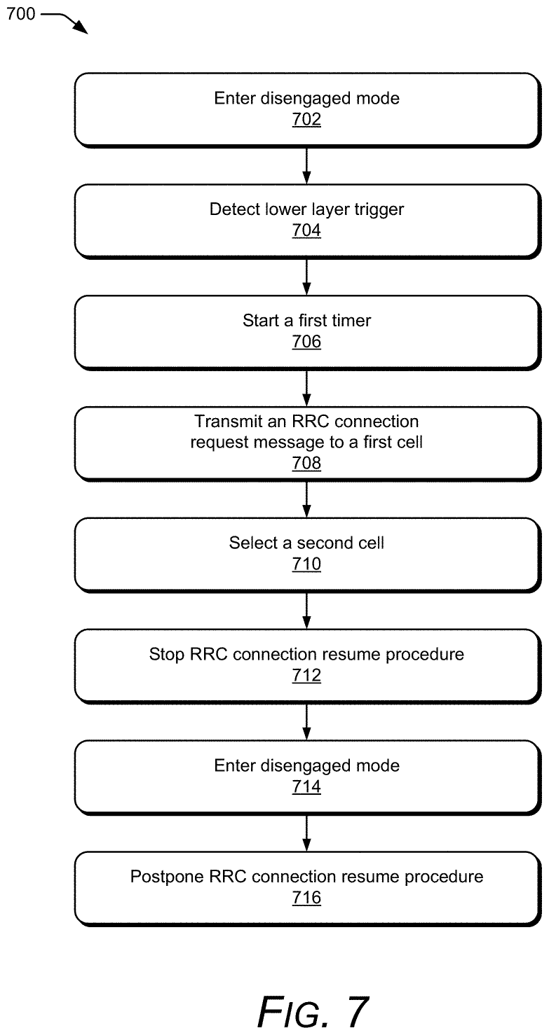

FIGS. 6 and 7 respectively illustrate example methods 600 and 700 performed by a UE for handling RRC connection resume procedure failures after cell reselection. Methods 600 and 700 are illustrated as sets of operations (or acts) performed but not necessarily limited to the order or combinations in which the operations are shown herein. Further, any of one or more of the operations may be repeated, combined, reorganized, skipped, or linked to provide a wide array of additional and/or alternate methods. In portions of the following discussion, reference may be made to environments 100 and 400 of FIGS. 1 and 4, device diagrams 200 of FIG. 2, the wireless networking stack 500 of FIG. 5, the example user equipment states 300 of FIG. 3, and entities detailed in FIGS. 1-5, a reference to which is made for example only. The techniques are not limited to performance by one entity or multiple entities operating on one device.

In methods 600 and 700 the UE 110 may be implemented as any suitable computing or electronic device, such as a user equipment device, a mobile communication device, a computing device, a client device, a mobile phone, a tablet computer, a laptop computer, a communication device, an entertainment device, a gaming device, a mobile gaming console, a personal media device, a media playback device, a charging station, an Advanced Driver Assistance System (ADAS), a point-of-sale (POS) transaction system, a health monitoring device, a drone, a camera, a wearable smart-device, a navigation device, a mobile-internet device (MID), an Internet home appliance capable of wireless Internet access and browsing, an Internet of Things (IoT) device, a Fifth Generation New Radio user equipment, and/or other types of user devices.

The base station 120 may represent or be implemented as another device, radio access node, wireless communication node, or other suitable piece of equipment that facilitates wireless communication (through a wireless link) between user equipment(s) and a communication network, such as a Next Generation Base NodeB (gNB) base station, an Enhanced NodeB (eNB) base station, an eNodeB base station, a base transceiver system, a Wireless Local Access Network (WLAN) router, a satellite, a terrestrial television broadcast tower, an access point, a peer-to-peer device, another smartphone acting as a base station, and so forth.

FIG. 6 illustrates an example method 600 of a UE 110 for handling RRC connection resume procedure failures after cell reselection. At 602, the UE enters a first disengaged mode 324 (e.g., idle mode 314, inactive mode 316) with a first cell. For example, the UE 110 is connected to a first cell (e.g., base station 121) and enters an inactive mode 316 (e.g., an RRC_INACTIVE state) with the first cell (e.g., base station 121).

At 604, the UE detects an upper layer trigger requesting resumption of an RRC connection. For example, an upper layer request (e.g., from the NAS layer 524, from the 5GMM layer 528) of the UE 110 can trigger the UE 110 to request resumption of the RRC connection with the first cell (e.g., base station 121).

At 606, the UE starts a first timer. For example, the UE 110 starts a T319 timer.

At 608, the UE transmits an RRC connection resume request message to the network (e.g., first cell). For example, the UE 110 transmits an RRC connection resume request message to base station 121.

At 610, before the first timer expires, the UE initiates a cell reselection procedure and selects a second cell. For example, before the T319 timer expires, the UE 110 initiates a cell reselection procedure and reselects to base station 123. The UE 110 may consider the first cell (e.g., base station 121) as a barred cell.

At 612, the UE stops the RRC connection resume procedure. For example, the UE 110 stops the RRC connection resume procedure (the RRC connection resume procedure fails). In aspects, the UE can also stop the first timer (e.g., T319 timer), if it is running.

At 614, after stopping the RRC connection resume procedure, the UE informs the upper layer of the RRC connection resume procedure failure and the UE enters another disengaged mode 324 (e.g., idle mode 314). For example, the UE 110 informs the NAS layer 524 and/or the 5GMM layer 528 of the RRC connection resume procedure failure and the UE 110 enters an idle mode 314 (e.g., RRC_IDLE state). In aspects, the UE 110 may restart the RRC connection resume procedure.

FIG. 7 illustrates another example method 700 of a UE for the handling of an RRC connection resume procedure failure after cell reselection in a UE. At 702, the UE enters a first disengaged mode 324 (e.g., idle mode 314, inactive mode 316) with a cell. For example, the UE 110 is connected to a first cell (e.g., base station 121) and enters an inactive mode 316 (e.g., RRC_INACTIVE state) with first cell (e.g., base station 121).

At 704, the UE detects a trigger that initiates a connection resume procedure. For example, the UE 110 detects a trigger from a lower layer (e.g., RRC layer 522) of the UE 110.

At 706, the UE starts a first timer. For example, the UE 110 starts a T319 timer.

At 708, responsive to detecting the trigger, the UE transmits an RRC connection resume request message to the network (e.g., first cell). For example, responsive to detecting the trigger, the UE 110 transmits an RRC connection resume request message to the base station 121.

At 710, before the first timer expires, the UE initiates a cell reselection procedure and selects a second cell. For example, before the T319 timer expires, the UE 110 initiates a cell reselection procedure and reselects to the base station 123. The UE 110 may consider the first cell (e.g., base station 121) as a barred cell.

At 712, the UE stops the RRC connection resume procedure. For example, the UE 110 stops the RRC connection resume procedure (the RRC connection resume procedure fails). In aspects, the UE can also stop the first timer (e.g., T319 timer), if it is running

At 714, after stopping the RRC connection resume procedure and the UE enters another disengaged mode 324 (e.g., idle mode 314). For example, the UE 110 stops the RRC connection resume procedure and enters idle mode 314 (e.g., the RRC_IDLE state). At 716, the UE postpones the RRC connection resume procedure and stays in the disengaged mode 324 (e.g., RRC_IDLE). In aspects, the UE further sends an indication to inform an upper layer (e.g., the NAS layer 524, the 5GMM layer 528) that the RRC connection resume procedure failed and that the UE 110 is in a disengaged mode 324 (e.g., RRC_IDLE).

### EXAMPLES

In the following section, some examples are described:

### Example 1

A method of handling a radio resource control (RRC) connection resume procedure failure after cell reselection in a user equipment (UE) in a disengaged mode with a first cell, the first example method comprising: the UE detecting a trigger for resumption of the RRC connection from an upper layer of the UE or from the UE; starting a first timer; in response to detecting the trigger, the UE transmitting an RRC connection resume request message to the first cell; before the first timer expires, the UE initiating a cell reselection procedure and reselecting to a second cell; responsive to selecting the second cell, the UE stopping the first timer, if it is running; the UE stopping the RRC connection resume procedure; and wherein if the trigger was the UE, the UE postponing the RRC connection resume procedure and staying in the disengaged mode, and wherein if the trigger was the upper layer of the UE either: the UE informing the upper layer of the RRC connection resume procedure stopping, or the UE returning to the disengaged mode, or the UE informing the upper layer of the RRC connection resume procedure stopping and the UE returning to the disengaged mode.

### Example 2

The method of example 1, wherein the disengaged mode with a first cell is either RRC_INACTIVE state or RRC_IDLE state.

### Example 3

The method of at least one of the preceding examples, wherein the first timer is a T319 timer.

### Example 4

The method of at least one of the preceding examples, wherein the trigger comprises: one or more of an upper layer of the UE requesting resumption of an RRC connection and a lower layer of the UE receiving a trigger message from the first cell.

### Example 5

The method of at least one of the preceding examples, wherein the trigger comprises: an upper layer of the UE requesting resumption of an RRC connection; and wherein after stopping the RRC connection resume procedure, the UE restarts the RRC connection resume procedure.

### Example 6

The method of at least one of the preceding examples, wherein the trigger comprises: a procedure initiated by the UE; and wherein after stopping the RRC connection resume procedure, the UE stays in the disengaged mode and sends an indication to inform an upper layer that the RRC connection resume procedure stopped and that the UE is still in the disengaged mode.

### Example 7

The method of at least one of the preceding examples, wherein the disengaged mode is RRC_INACTIVE state.

### Example 8

The method of at least one of the preceding examples, wherein prior to selecting the first cell, the UE is in a disengaged mode with a third cell.

### Example 9

The method of at least one of the preceding examples, wherein the RRC connection resume procedure is triggered by the UE initiating a periodic RAN notification area update procedure requesting a RAN notification area update from a network.

### Example 10

The method of at least one of the preceding examples, wherein the UE starts a periodic second timer when the UE enters the disengaged mode with the third cell; and wherein the UE initiates the periodic RAN notification area update procedure after the second timer expires.

### Example 11

The method of at least one of the preceding examples, wherein the periodic second timer is a T380 timer.

### Example 12

The method of at least one of the preceding examples, wherein in response to a RAN notification area of the first cell being different than a RAN notification area of the third cell, the RRC connection resume procedure is triggered by the UE initiating a periodic RAN notification area update (RNA update) procedure requesting an RNA update from a network.

### Example 13

The method of at least one of the preceding examples, wherein in response to a RAN notification area of the second cell not belonging to a RAN notification area of the third cell, the trigger comprises: the UE initiating a periodic RAN notification area update (RNA update) procedure requesting an RNA update from a network.

### Example 14

The method of at least one of the preceding examples, wherein the trigger comprises: a procedure initiated by the UE; wherein after stopping the RRC connection resume procedure the UE postpones the RRC connection resume procedure; and wherein the UE reinitiates the postponed RRC connection resume procedure in response to one or more of: a RAN notification area of the second cell is different from a RAN notification area of the third cell, and the RAN notification area of the second cell does not belong to the RAN notification area of the third cell.

### Example 15

The method of at least one of the preceding examples, wherein the UE considers the first cell as a barred cell after the UE reselects to the second cell.

### Example 16

The method of at least one of the preceding examples, wherein the UE informs an upper layer of the UE that the first cell is a barred cell.

### Example 17

The method of at least one of the preceding examples, wherein the UE starts a third timer after it bars the first cell.

### Example 18

The method of at least one of the preceding examples, wherein after the third timer expires, the UE informing an upper layer that barring the first cell alleviated the RRC connection resume procedure.

### Example 19

The method of at least one of the preceding examples, wherein after the third timer expires, the UE directs an upper layer to reinitiate the RRC connection resume procedure.

### Example 20

The method of at least one of the preceding examples, wherein the UE starts a fourth timer after the UE postpones the RRC connection resume procedure.

### Example 21

The method of at least one of the preceding examples, wherein the UE reinitiates the RRC connection resume procedure after the fourth timer expires.

### Example 22

The method of at least one of the preceding examples, wherein the UE reselects to a fifth cell before the fourth timer expires.

### Example 23

The method of at least one of the preceding examples, wherein the UE stops the fourth timer, if it is running, and the UE reinitiates the RRC connection resume procedure when either: a RAN notification area of the second cell and a RAN notification area of the fifth cell are different, or the RAN notification area of the second cell does not belong to the RAN notification area of the fifth cell.

### Example 24

The method of at least one of the preceding examples, wherein the UE enters an inactive mode without performing the RRC connection resume procedure when either: a RAN notification area of the second cell and a RAN notification area of the fifth cell are the same, or the RAN notification area of the second cell belongs to the RAN notification area of the fifth cell.

### Example 25

The method of at least one of the preceding examples, wherein the UE discards one or more of any stored access stratum context, a radio network temporary identifier I-RNTI, an information element ran-PagingCycle, and an information element ran-NotificationAreaInfo when entering the idle mode.

### Example 26

The method of at least one of the preceding examples, further comprising the UE releasing all radio resources of the UE.

### Example 27

The method of at least one of the preceding examples, wherein the UE releases one or more of a radio link control (RLC) entity, a medium access control (MAC) configuration, or an associated packet data convergence protocol (PDCP) entity for all established radio bearers (RB).

### Example 28

A method of handling a radio resource control (RRC) connection resume procedure failure after cell reselection in a user equipment (UE) in an inactive mode with a first cell, the method comprising: an upper layer of the UE requesting resumption of an RRC connection; the UE starting a first timer; the UE transmitting an RRC connection resume request message to the first cell; before the first timer expires, the UE initiating a cell reselection procedure and reselecting to a second cell; the UE stopping the first timer, if it is running; and the UE stopping the RRC connection resume procedure, wherein after stopping the RRC connection resume procedure, the UE informing the upper layer of the RRC connection resume procedure stopping and the UE entering idle mode.

### Example 29

A method of handling a radio resource control (RRC) connection resume procedure failure after cell reselection in a user equipment (UE) in an inactive mode with a first cell, the method comprising: the UE triggering an RRC connection resume request message; the UE starting a first timer; the UE transmitting an RRC connection resume request message to the first cell; before the first timer expires, the UE initiating a cell reselection procedure and reselecting to a second cell; the UE stopping the first timer, if it is running; and the UE stopping the RRC connection resume procedure, wherein after stopping the RRC connection resume procedure the UE postpones the RRC connection resume procedure.

### Example 30

A method of handling a radio resource control (RRC) connection resume procedure failure after cell reselection in a user equipment (UE) in an inactive mode with a first cell, the method comprising: an upper layer of the UE triggering an RRC connection resume request; the UE starting a first timer; the UE transmitting an RRC connection resume request message to the first cell; before the first timer expires, the UE initiating a cell reselection procedure and reselecting to a second cell; the UE stops the first timer, if it is running; and the UE stops the RRC connection resume procedure, wherein after stopping the RRC connection resume procedure the UE restarts the RRC connection resume procedure.

### Example 31

A method of handling a radio resource control (RRC) connection resume procedure failure after cell reselection in a user equipment (UE) in an inactive mode with a first cell, the method comprising: the UE triggering an RRC connection resume request; the UE starting a first timer; the UE transmitting an RRC connection resume request message to the first cell; before the first timer expires, the UE initiating a cell reselection procedure and reselecting to a second cell; the UE stops the first timer, if it is running; and the UE stops the RRC connection resume procedure.

### Example 32

A method, implemented by a user equipment, of handling a radio resource control (RRC) connection resume procedure failure after cell reselection, the method comprising: selecting a first cell; entering an RRC_INACTIVE state with the first cell; detecting a trigger that initiates an RRC connection resume procedure; starting a first timer; responsive to detecting the trigger, transmitting an RRC connection resume request message to the first cell; before the first timer expires, initiating a cell reselection procedure and selecting a second cell; stopping the RRC connection resume procedure; informing the upper layer of the RRC connection resume procedure failure; and entering an RRC_IDLE state.

### Example 33

The method of example 32, wherein the first timer is a T319 timer.

### Example 34

The method of at least one of the preceding examples 32 and 33, further comprising at least one of receiving the trigger from the upper layer, wherein the trigger comprises a request to resume a radio resource control connection with the first cell or restarting the radio resource control connection resume procedure.

### Example 35

The method of at least one of the preceding examples 32 to 34, further comprising at least one of after selecting the second cell, stopping the first timer if it is running; after selecting the second cell, treating the first cell as a barred cell; sending an indication to the upper layer indicating that the first cell is a barred cell; or after barring the first cell, starting a third timer.

### Example 36

The method of example 35, further comprising after the third timer expires, directing the upper layer to reinitiate the radio resource control connection resume procedure.

### Example 37

The method of at least one of the preceding examples 32 to 36, wherein the stopping of the radio resource control connection resume procedure further comprises starting a fourth timer; and wherein after the fourth timer expires, reinitiating the radio resource control connection resume procedure.

### Example 38

The method of example 37, wherein prior to selecting to the first cell, the user equipment was in a disengaged mode with a third cell; the method further comprising: stopping the fourth timer, if it is running; and reinitiating the radio resource control connection resume procedure when at least one of: a RAN notification area of the second cell and a RAN notification area of the third cell are different; or the RAN notification area of the second cell does not belong to the RAN notification area of the third cell.

### Example 39

The method of at least one of the preceding examples 37 or 38, wherein prior to selecting to the first cell, the user equipment was in a disengaged mode with a third cell; the method further comprising: stopping the fourth timer, if it is running; and entering the RRC_INACTIVE state without restarting the radio resource control connection resume procedure when at least one of: a RAN notification area of the second cell and a RAN notification area of the third cell are the same; or the RAN notification area of the second cell belongs to the RAN notification area of the third cell.

### Example 40

The method of at least one of the preceding examples 32 to 39, releasing all radio resources of the user equipment; or releasing one or more of a radio link control entity, a Media Access Control configuration, and an associated packet data convergence protocol entity for all established radio bearers; or discarding, wherein when entering the RRC_IDLE state, at least one of: any stored access stratum context, a radio network temporary identifier, an information element ran-PagingCycle, or an information element ran-NotificationAreaInfo.

### Example 41

A user device comprising: a processor; and a computer-readable storage medium having stored thereon instructions that responsive to execution by the processor, cause the processor to execute the method of any of preceding examples 32 to 40.

### Example 42

A method, implemented by user equipment, of handling a radio resource control connection resume procedure failure after cell reselection, the method comprising: selecting a first cell; entering a disengaged mode with the first cell; detecting a trigger that initiates a radio resource control connection resume procedure; starting a first timer; responsive to detecting the trigger, transmitting a radio resource control connection resume request message to the first cell; before the first timer expires, initiating a cell reselection procedure and selecting a second cell; stopping the radio resource control connection resume procedure; postponing the radio resource control connection resume procedure; and staying in the disengaged mode.

### Example 43

The method of example 42, wherein the disengaged mode is an RRC_INACTIVE state.

### Example 44

The method of at least one of preceding examples 42 and 42, responsive to selecting the second cell, stopping the first timer, if it is running; receiving the trigger from a lower layer of the user equipment; receiving the trigger from a radio resource control layer of the user equipment; or sending, by the lower layer of the user equipment, the trigger responsive to receiving a trigger message from the first cell.

### Example 45

The method of at least one of the preceding examples 42 to 44, further comprising restarting the radio resource control connection resume procedure after stopping the radio resource control connection resume procedure.

### Example 46

The method of at least one of the preceding examples 42 to 45, further comprising after stopping the radio resource control connection resume procedure, sending an indication informing an upper layer that the radio resource control connection resume procedure stopped and that the user equipment is still in the disengaged mode.

### Example 47

The method of at least one of the preceding examples 42 to 46, wherein a periodic RAN notification area update triggers the radio resource control connection resume procedure.

### Example 48

The method of at least one of the preceding examples 42 to 47, wherein prior to selecting the first cell, the user equipment is in a disengaged mode with a third cell; the method further comprising: starting a second timer when the user equipment enters the disengaged mode with the third cell; and initiating a periodic RAN notification area update procedure after the second timer expires.

### Example 49

The method of at least one of the preceding examples 42 to 48, wherein the second timer is a T380 timer.

### Example 50

The method of at least one of the preceding examples 42 to 59, determining that a RAN notification area of the first cell is different than a RAN notification area of the third cell; and initiating at least one of: a periodic RAN notification area update; a periodic update; or a RAN notification area change.

### Example 51

The method of at least one of the preceding examples 42 to 50, wherein responsive to a RAN notification area of the second cell not belonging to a RAN notification area of the third cell, the trigger comprises initiating a periodic RAN notification area update procedure requesting a RAN notification update from a network.

### Example 52

The method of at least one of the preceding examples 42 to 51, wherein the selecting of the second cell further comprises at least one of: treating the first cell as a barred cell; informing an upper layer that the first cell is a barred cell; treating the first cell as a barred cell after selecting the second cell; or starting a third timer after barring the first cell, wherein after the third timer expires, directing the upper layer to reinitiate the radio resource control connection resume procedure.

### Example 53

The method of at least one of the preceding examples 42 to 52, wherein prior to selecting the first cell, the user equipment is in a disengaged mode with a third cell, the method further comprising: starting a fourth timer after postponing the radio resource control connection resume procedure, and performing an operation of at least one of: reselecting the third cell before the fourth timer expires; reinitiating the radio resource control connection resume procedure after the fourth timer expires; reinitiating the radio resource control connection resume procedure when a RAN notification area of the second cell and a RAN notification area of the third cell are different; or reinitiating the radio resource control connection resume procedure when the RAN notification area of the second cell does not belong to the RAN notification area of the third cell.

### Example 54

The method of at least one of the preceding examples 42 to 52, wherein after stopping the RRC connection resume procedure the UE device postpones the RRC connection resume procedure; and wherein the UE device reinitiates the postponed RRC connection resume procedure in response to at least one of: a RAN notification area of second cell is different from a RAN notification area of the third cell, or the RAN notification area of second cell does not belong to the RAN notification area of the third cell.

### Example 55

The method of at least one of the preceding examples 42 to 53, wherein prior to selecting the first cell, the UE device is in a disengaged mode with a third cell; and wherein the UE device enters the RRC_INACTIVE state without restarting the RRC connection resume procedure when at least one of: a RAN notification area of the second cell and a RAN notification area of the third cell are the same; or the RAN notification area of the second cell belongs to the RAN notification area of the third cell

### Example 56

A user device comprising: a processor; and a computer-readable storage medium having stored thereon instructions that responsive to execution by the processor, cause the processor to execute the method of any of examples 42 to 55.

### Example 57

A method, implemented by user equipment, of handling a radio resource control connection resume procedure failure after cell reselection, the method comprising: selecting a first cell; entering radio resource inactive state with the first cell; detecting a trigger that initiates a radio resource control connection resume procedure; responsive to detecting the trigger, starting a first timer; responsive to detecting the trigger, transmitting a radio resource control connection resume request message to the first cell; before the first timer expires, initiating a cell reselection procedure to select a second cell; stopping the radio resource control connection resume procedure; informing an upper layer of the radio resource control connection resume procedure failure; and entering a radio resource idle state.

### Example 58

The method of example 57, wherein the first timer is a T319 timer.

### Example 59

The method of at least one of examples 57 and 58, further comprising at least one of: receiving the trigger from the upper layer, wherein the trigger comprises a request to resume a radio resource control connection with the first cell; or restarting the radio resource control connection resume procedure.

### Example 60

The method of at least one of examples 57-59, further comprising at least one of: upon entering the radio resource idle state, stopping the first timer if it is running; after selecting the second cell, treating the first cell as a barred cell; sending an indication to the upper layer indicating that the first cell is a barred cell; or after barring the first cell, starting a third timer.

### Example 61

The method of example 60, further comprising: after the third timer expires, directing the upper layer to reinitiate the radio resource control connection resume procedure.

### Example 62

The method of at least one of examples 57-61: wherein the stopping of the radio resource control connection resume procedure further comprises: starting a fourth timer; and wherein after the fourth timer expires, reinitiating the radio resource control connection resume procedure.

### Example 63

The method of example 62: wherein prior to selecting the first cell, the user equipment was in a disengaged mode with a third cell; the method further comprising: stopping the fourth timer, if it is running; and reinitiating the radio resource control connection resume procedure when at least one of: a RAN notification area of the second cell and a RAN notification area of the third cell are different; or the RAN notification area of the second cell does not belong to the RAN notification area of the third cell.

### Example 64

The method of at least one of examples 62 or 63: wherein prior to selecting to the first cell, the user equipment was in a disengaged mode with a third cell; the method further comprising: stopping the fourth timer, if it is running; and entering the radio resource inactive state without restarting the radio resource control connection resume procedure when at least one of: a RAN notification area of the second cell and a RAN notification area of the third cell are the same; or the RAN notification area of the second cell belongs to the RAN notification area of the third cell.

### Example 65

The method of at least one of examples 57-64, further comprising at least one of: releasing all radio resources of the user equipment; or releasing one or more of a radio link control entity, a Media Access Control configuration, and an associated packet data convergence protocol entity for all established radio bearers; or discarding, wherein when entering the radio resource idle state, at least one of: any stored access stratum context, a radio network temporary identifier, an information element ran-PagingCycle, or an information element ran-NotificationAreaInfo.

### Example 66

A user device comprising: a processor; and a computer-readable storage medium having stored thereon instructions that, responsive to execution by the processor, cause the processor to execute the method of any of examples 57 to 65.

### Example 67

A method, implemented by user equipment, of handling a radio resource control connection resume procedure failure after cell reselection, the method comprising: selecting a first cell; entering a disengaged mode with the first cell; detecting a trigger that initiates a radio resource control connection resume procedure; responsive to detecting the trigger, starting a first timer; responsive to detecting the trigger, transmitting a radio resource control connection resume request message to the first cell; before the first timer expires, initiating a cell reselection procedure to select a second cell; stopping the radio resource control connection resume procedure; and staying in the disengaged mode.

### Example 68

The method of example 67, further comprising at least one of: responsive to selecting the second cell, stopping the first timer, if it is running; receiving the trigger from a lower layer of the user equipment; receiving the trigger from a radio resource control layer of the user equipment; or sending, by the lower layer of the user equipment, the trigger responsive to receiving a trigger message from the first cell.

### Example 69

The method of at least one of examples 67 or 68, further comprising: restarting the radio resource control connection resume procedure after stopping the radio resource control connection resume procedure.

### Example 70

The method of at least one of examples 67-69, further comprising: after stopping the radio resource control connection resume procedure, sending an indication informing an upper layer that the radio resource control connection resume procedure stopped and that the user equipment is still in the disengaged mode.

### Example 71

The method of at least one of examples 67-70, wherein a RAN notification area update triggers the radio resource control connection resume procedure.

### Example 72

The method of at least one of examples 67-71, wherein the selecting of the second cell further comprises at least one of: treating the first cell as a barred cell; informing an upper layer that the first cell is a barred cell; treating the first cell as a barred cell after selecting the second cell; or starting a third timer after barring the first cell, wherein after the third timer expires, directing the upper layer to reinitiate the radio resource control connection resume procedure.

### Example 73

A user device comprising: a processor; and a computer-readable storage medium having stored thereon instructions that, responsive to execution by the processor, cause the processor to execute the method of any of examples 67-73.

### Conclusion

Although techniques and apparatuses for handling radio resource control (RRC) connection resume procedure failures after cell reselection have been described in language specific to features and/or methods, it is to be understood that the subject of the appended claims is not necessarily limited to the specific features or methods described. Rather, the specific features and methods are disclosed as example implementations of the handling of RRC connection resume procedure failures after cell reselection.

1. A method, implemented by user equipment, of handling a radio resource control connection resume procedure failure after cell reselection, the method comprising:
selecting a first cell;
entering radio resource inactive state with the first cell;
detecting a trigger that initiates a radio resource control connection resume procedure;
responsive to detecting the trigger, starting a first timer;
responsive to detecting the trigger, transmitting a radio resource control connection resume request message to the first cell;
before the first timer expires, initiating a cell reselection procedure to select a second cell;
stopping the radio resource control connection resume procedure;
starting a fourth timer;
informing an upper layer of the radio resource control connection resume procedure failure;
entering a radio resource idle state; and
after the fourth timer expires, reinitiating the radio resource control connection resume procedure.

2. The method of claim 1, wherein the first timer is a T319 timer.

3. The method of claim 1 wherein the detecting comprises:
receiving the trigger from the upper layer, the trigger comprises a request to resume a radio resource control connection with the first cell.

4. The method of claim 1, further comprising:
upon entering the radio resource idle state, stopping the first timer if it is running;
after selecting the second cell, treating the first cell as a barred cell; or after barring the first cell, starting a third timer.

5. The method of claim 1, further comprising:
upon entering the radio resource idle state, stopping the first timer if it is running;
after selecting the second cell, treating the first cell as a barred cell^{.}, after barring the first cell, starting a third timer; and
after the third timer expires, directing the upper layer to reinitiate the radio resource control connection resume procedure.

6. The method of claim 4
wherein the detecting comprises:
receiving the trigger from the upper layer, the trigger comprising a request to resume a radio resource control connection with the first cell; and further comprising:
sending an indication to the upper layer indicating that the first cell is a barred cell.

7. The method of claim 1:
wherein prior to selecting the first cell, the user equipment was in a disengaged mode with a third cell;
the method further comprising:
stopping the fourth timer, if it is running; and
reinitiating the radio resource control connection resume procedure when a RAN notification area of the second cell and a RAN notification area of the third cell are different.

8. The method of claim 1,
wherein prior to selecting to the first cell, the user equipment was in a disengaged mode with a third cell;
the method further comprising:
stopping the fourth timer, if it is running; and
entering the radio resource inactive state without reinitiating the radio resource control connection resume procedure when a RAN notification area of the second cell and a RAN notification area of the third cell are the same.

9. The method of claim 1, further comprising at least one of:
releasing all radio resources of the user equipment;
releasing at least of:
a radio link control entity,
a Media Access Control configuration, or
an associated packet data convergence protocol entity for all established radio bearers; or
discarding, when entering the radio resource idle state, at least one of:
any stored access stratum context,
a radio network temporary identifier,
an information element ran-PagingCycle, or
an information element ran-NotificationAreaInfo.

10-17. (canceled)

18. The method of claim 1, wherein prior to selecting the first cell, the user equipment was in a disengaged mode with a third cell, the method further comprising:
stopping the fourth timer, if it is running; and
reinitiating the radio resource control connection resume procedure when a RAN notification area of the second cell does not belong to the RAN notification area of the third cell.

19. The method of claim 1, wherein prior to selecting to the first cell, the user equipment was in a disengaged mode with a third cell, the method further comprising:
stopping the fourth timer, if it is running; and
entering the radio resource inactive state without reinitiating the radio resource control connection resume procedure when a RAN notification area of the second cell belongs to the RAN notification area of the third cell.

20. The method of claim 1, further comprising:
reinitiating the radio resource control connection resume procedure.

21. A user equipment comprising:
a processor;
one or more hardware-based transceivers; and
a computer-readable storage media having stored thereon instructions that, responsive to execution by the processor, cause the processor perform operations comprising:
select a first cell;
enter a radio resource inactive state with the first cell;
detect a trigger that initiates a radio resource control connection resume procedure;
responsive to detecting the trigger, start a first timer;
responsive to detecting the trigger, transmit a radio resource control connection resume request message to the first cell;
before the first timer expires, initiate a cell reselection procedure to select a second cell;
stop the radio resource control connection resume procedure;
start a fourth timer;
inform an upper layer of the radio resource control connection resume procedure failure;
enter a radio resource idle state; and
after the fourth timer expires, reinitiate the radio resource control connection resume procedure.

22. The user equipment of claim 21, wherein the operation of detect a trigger that initiates a radio resource control connection resume procedure comprises the processor further performs operations comprising:
receive the trigger from the upper layer, the trigger comprising a request to resume a radio resource control connection with the first cell.

23. The user equipment of claim 21, wherein the processor further performs operations comprising:
upon entering the radio resource idle state, stop the first timer if it is running;
after selecting the second cell, treat the first cell as a barred cell; and
after barring the first cell, start a third timer.

24. The user equipment of claim 23, wherein the operation of detect a trigger that initiates a radio resource control connection resume procedure comprises the processor further performs operations comprising:
receive the trigger from the upper layer, the trigger comprising a request to resume a radio resource control connection with the first cell; and
further comprising:
send an indication to the upper layer indicating that the first cell is a barred cell.

25. The user equipment of claim 21, wherein the processor further performs operations comprising:
upon entering the radio resource idle state, stop the first timer if it is running;
after selecting the second cell, treat the first cell as a barred cell;
after barring the first cell, start a third timer; and
after the third timer expires, direct the upper layer to reinitiate the radio resource control connection resume procedure.

26. The user equipment of claim 21,
wherein prior to selecting the first cell, the user equipment was in a disengaged mode with a third cell, and
wherein the processor further performs operations comprising:
stop the fourth timer, if it is running; and
reinitiate the radio resource control connection resume procedure when a RAN notification area of the second cell and a RAN notification area of the third cell are different.

27. The user equipment of claim 21,
wherein prior to selecting to the first cell, the user equipment was in a disengaged mode with a third cell, and
wherein the processor further performs operations comprising:
stop the fourth timer, if it is running; and
enter the radio resource inactive state without restarting the radio resource control connection resume procedure when a RAN notification area of the second cell and a RAN notification area of the third cell are the same.

28. The user equipment of claim 21, wherein the processor further performs operations comprising at least one of:
release all radio resources of the user equipment;
release at least one of:
a radio link control entity,
a Media Access Control configuration, or
an associated packet data convergence protocol entity for all established radio bearers; or
discard, when entering the radio resource idle state, at least one of:
any stored access stratum context,
a radio network temporary identifier,
an information element ran-PagingCycle, or
an information element ran-NotificationAreaInfo.
